(19) United States
(12) Patent Application Publication
(10) Pub. No.: US 2018/0131076 A1
(43) Pub. Date: May 10, 2018

(54) WIRELESS COMMUNICATION DEVICE

(71) Applicant: ASUSTeK COMPUTER INC., TAIPEI (TW)

(72) Inventors: Yu-An CHEN, Taipei (TW); Ten-Long DAN, Taipei (TW); Li-Ru LAI, Taipei (TW)

(21) Appl. No.: 15/790,128

(22) Filed: Oct. 23, 2017

(30) Foreign Application Priority Data
Nov. 4, 2016 (TW) 105216905

(51) Int. Cl. H01Q 1/24; H01Q 1/08; H01Q 1/12

(52) U.S. Cl. CPC H01Q 1/24; H01Q 1/084; H01R 2201/02; H01Q 1/1207; H01Q 1/1235

(57) ABSTRACT

A wireless communication device is provided. The wireless communication device comprises a main body, an external antenna and a cushion washer. The main body includes a first connector. The external antenna includes a second connector detachably connected to the first connector. The cushion washer is sandwiched between the main body and the second connector.

### CROSS-REFERENCE TO RELATED APPLICATION

This application claims the priority benefit of Taiwan application serial No. 105216905, filed on Nov. 4, 2016. The entirety of the above-mentioned patent application is hereby incorporated by references herein and made a part of specification.

### BACKGROUND OF THE INVENTION

### Field of the Invention

The disclosure relates to a wireless communication device and, more specifically, to a wireless communication device with an external antenna.

### Description of the Related Art

Generally, an external antenna is tightly connected to an antenna connector of an electronic device via a thread connection to enhance a signal reception range of the electronic device. Usually, a user may need to swing the external antenna over and over again to have a better signal reception range.

However, the connection between the external antenna and the antenna connector of the electronic device becomes weak while the external antenna is repeatedly swung. The external antenna may loosely connect to the antenna connector and even unexpectedly sag relatively to the antenna connector, which affects the appearance of the electronic device and the stability of the signal transmission.

### BRIEF SUMMARY OF THE INVENTION

A wireless communication device capable of preventing the disconnection between the external antenna and the main body of the wireless communication device is provided.

According to an aspect of the disclosure, a wireless communication device is provided. The wireless communication device comprises a main body, an external antenna and a cushion washer. The main body includes a first connector. The external antenna includes a second connector detachably connected to the first connector. The cushion washer is sandwiched between the main body and the second connector.

In embodiments, the cushion washer is sandwiched between the main body and the second connector, the connection between the external antenna and the main body is enhanced due to the friction interface between the cushion washer and the external antenna and the main body. Thus, the external antenna does not easily loose from the main body and does not unexpectedly sag relatively to the antenna connector, which improves the appearance of the electronic device and ensures the stability of the signal transmission.

### BRIEF DESCRIPTION OF THE DRAWINGS

These and other features, aspects and advantages of the disclosure will become better understood with regard to the following embodiments and accompanying drawings.

FIG. 1 is a perspective view of a wireless communication device in an embodiment;

FIG. 2 is an exploded view of the wireless communication device in FIG. 1 in an embodiment;

FIG. 3A is a perspective view of a cushion washer in an embodiment;

FIG. 3B is a perspective view of a cushion washer in an embodiment;

FIG. 4A is a schematic diagram showing an external antenna in an embodiment;

FIG. 4B is a longitudinal cross-section view of the cushion washer in FIG. 3B and the external antenna in FIG. 4A that are assembled in an embodiment;

FIG. 5 is a side view of a cushion washer in an embodiment;

FIG. 6 is an exploded view of a wireless communication device in an embodiment; and

FIG. 7 is an exploded view of a wireless communication device in an embodiment.

### DETAILED DESCRIPTION OF THE EMBODIMENTS

These and other features, aspects, and advantages of the disclosure will become better understood with regard to the following description, appended claims, and accompanying drawings. However, the embodiments are not limited herein. The description of the operation of components is not used for limiting the execution sequence. Any equivalent device with the combination according to the disclosure is in the scope of the disclosure. The components shown in figures are not used for limit the size or the proportion.

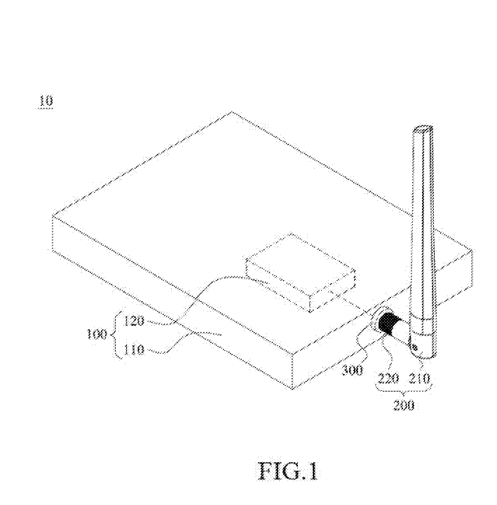

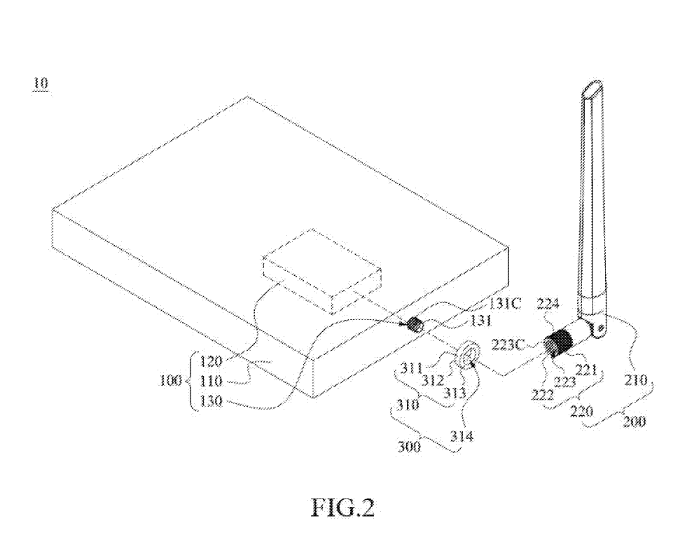

FIG. 1 is a perspective view of a wireless communication device 10 in an embodiment. FIG. 2 is an exploded view of the wireless communication device 10 in FIG. 1 in an embodiment. As shown in FIG. 1 and FIG. 2, in an embodiment, a wireless communication device 10 includes a main body 100, an external antenna 200 and a cushion washer 300.

The main body 100 includes a housing 110, a processing circuit 120 and a first connector 130. The first connector 130 is configured at the housing 110. The signal processing circuit 120 is disposed inside the housing 110. The signal processing circuit 120 is electrically connected to the first connector 130. The external antenna 200 includes an antenna body 210 and a second connector 220. The antenna body 210 is electrically connected to the second connector 220.

The second connector 220 is detachably connected to the first connector 130. With the first connector 130 and the second connector 220 that are electrically connected with each other, the signal processing circuit 120 is electrically connected to the antenna body 210. The signal processing circuit 120 transmits signals via the antenna body 210, or processes signals from the antenna body 210. The cushion washer 300 is sandwiched between the housing 110 and the second connector 220. That is, when the second connector 220 is connected to the first connector 130, the cushion washer 300 is squeezed between the housing 110 and the second connector 220.

As shown in FIG. 1, with the friction between the cushion washer 300 and the housing 110, and the friction between the cushion washer 300 and the second connector 220, the connection between the external antenna 200 and the main body 100 is enhanced. Therefore, the external antenna 200 does not easily loose from the main body and does not unexpectedly sag relatively to the antenna connector, which improves the appearance of the electronic device and the stability of the signal transmission.

In the embodiment, the cushion washer 300 includes a ring body 310 and a through hole 314. For example, the ring body 310 is annular. The ring body includes an outer ring portion 311, a first even surface 312 and a second even surface 313. The first even surface 312 and the second even surface 313 are opposite to each other. The outer ring portion 311 is configured around the first even surface 312 and the second even surface 313. The outer ring portion 311 is connected to the first even surface 312 and the second even surface 313. The through hole 314 is formed through the ring body 310 to the first even surface 312 and the second even surface 313.

In an embodiment, the cushion washer 300 is an O-ring made of silicon or rubber. In an embodiment, the cushion washer 300 is made of other materials.

In an embodiment, the first connector 130 includes a stud 131. An outer ring portion of the stud 131 includes a first thread 131C. The second connector 220 is a threaded ring. The second connector 220 includes a frictional side surface 221, an end face 222 and a screw channel 223. The frictional side surface 221 surrounds and adjoins the end face 222. The screw channel 223 is configured at the end face 222. An inner surface of the screw channel includes a second thread 223C.

With the configuration of the first thread 131C and the second thread 223C, the stud 131 passes through the through hole 314 to be screwed within the screw channel 223. The first even surface 312 of the cushion washer 300 contacts with an outer surface of the housing 110 directly. The second even surface 313 of the cushion washer 300 contacts with the end face 222 of the second connector 220 directly. The frictional side surface 221 includes an anti-slip texture structure 224. In an embodiment, the connection mode of the stud and the screw channel is various according to requirements.

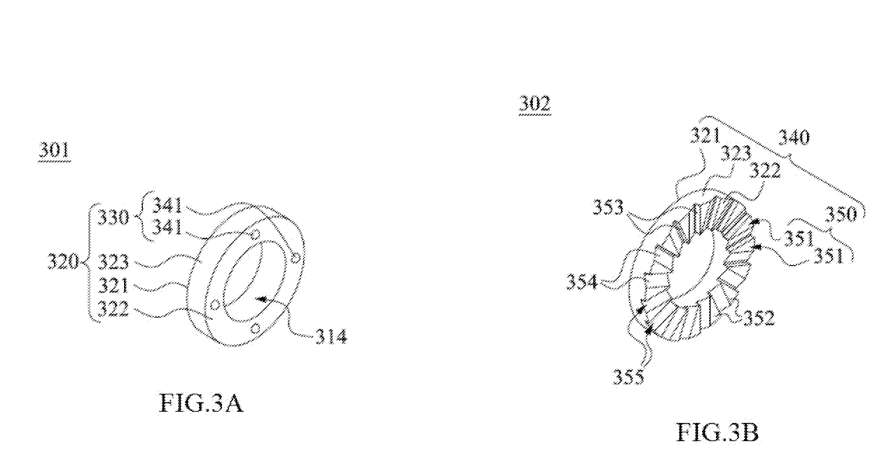

FIG. 3A is a perspective view of a cushion washer 301 in an embodiment. In an embodiment, a cushion washer 301 shown in FIG. 3A is similar to the cushion washer 200 shown in FIG. 2. The cushion washer 301 shown in FIG. 3A is different from the cushion washer 200 in that the cushion washer 301 includes a solid friction pattern 330 protruding from a side of the cushion washer 301.

In an embodiment, the cushion washer 301 includes a ring body 320 and the through hole 314. The ring body 320 is annular. The ring body 320 includes a first main surface 321, a second main surface 322, and an outer ring portion 323. The first main surface 321 and the second main surface 322 are configured opposite to each other. The outer ring portion 323 is configured around the first main surface 321 and the second main surface 322 to be connected with the first main surface 321 and the second main surface 322. The through hole 314 is formed through the ring body 320 to the first main surface 321 and the second main surface 322. The solid friction pattern 330 is formed at the second main surface 322.

Please refer to FIG. 2 and FIG. 3A. When the cushion washer 301 shown in FIG. 3A is sandwiched between the housing 110 and the second connector 220, the first main surface 321 of the cushion washer 301 contacts with the outer surface of the housing 110 directly. The solid friction pattern 330 of the ring body 320 contacts with the end face 222 of the second connector 220 directly to increase the friction between the external antenna and the housing 110.

Please refer to FIG. 2 and FIG. 3A. The solid friction pattern 330 includes a plurality of first protrusions 341. The first protrusions 341 are separately disposed on the second main surface 322 to contact with the end face 222 of the second connector 220 directly.

In an embodiment, four first protrusions 341 are hemispherical. The first protrusion 341 are arranged uniformly and equidistantly on the second main surface 322. Thus, under the push of the end face 222 of the second connector 220, the second main surface 322 and the first protrusions 341 provides a larger contact area to increase the friction therebetween to enhance the connection between the external antenna 200 and the main body 100. In an embodiment, the structure of the first protrusion is various according to requirements, which is not limited herein.

FIG. 3B is a perspective view of a cushion washer 302 in an embodiment. As shown in FIG. 3A and FIG. 3B, the cushion washer 301 in FIG. 3A and a cushion washer 302 in FIG. 3B are similar. The difference is that in the cushion washer 302 in FIG. 3B, the protrusion of the solid friction pattern 350 of the ring body 340 is not hemispherical. Instead, the solid friction pattern 350 includes a plurality of wedge-shaped second protrusions 351. The second protrusions 351 are configured around the through hole 314. That is, the second protrusions 351 are arranged on the second main surface 322 to surround the through hole 314. In an embodiment, the second protrusions are continuously arranged to surround the through hole.

Please refer to FIG. 2 and FIG. 3B. When the cushion washer 302 in FIG. 3B is sandwiched directly between the housing 110 and the second connector 220, the first main surface 321 of the cushion washer 302 contacts with the outer surface of the housing 110 directly. The solid friction pattern 350 of the ring body 320 contacts with the end face 222 of the second connector 220 directly to increase the friction between the external antenna and the housing.

In the embodiment, each second protrusion 351 includes a top surface 352, a vertical surface 353 and an inclined surface 354. The top surface 352 is triangle. The top surface 352 is configured opposite to the first main surface 321. The top surface 352 is between the vertical surface 353 and the inclined surface 354. The top surface 352 is connected to the vertical surface 353 and the inclined surface 354. The vertical surface 353 is perpendicular to the top surface 352.

In an embodiment, in any two adjacent second protrusions 351, the vertical surface 353 of one second protrusions 351 is adjacent to the inclined surfaces 354 of the other second protrusions 351, but not the vertical surface 353 of the other second protrusion 351. A gap 355 is formed between the vertical surface 353 of the second protrusion 351 and the inclined surface 354 of the adjacent second protrusion 351. In an embodiment, the structure of the second protrusion is various according to requirements, which is not limited herein.

When the solid friction pattern 350 of the ring body 320 contacts with the end face 222 of the second connector 220 directly, both the top surface 352 and the inclined surface 354 of the second protrusion 351 of the cushion washer 302 contacts with the end face 222 of the second connector 220 directly. Thus, due to the friction between the end face 222 with the top surface 352 and the inclined surface 354 of the second protrusion 351, the connection between the external antenna 200 and the main body 100 is enhanced.

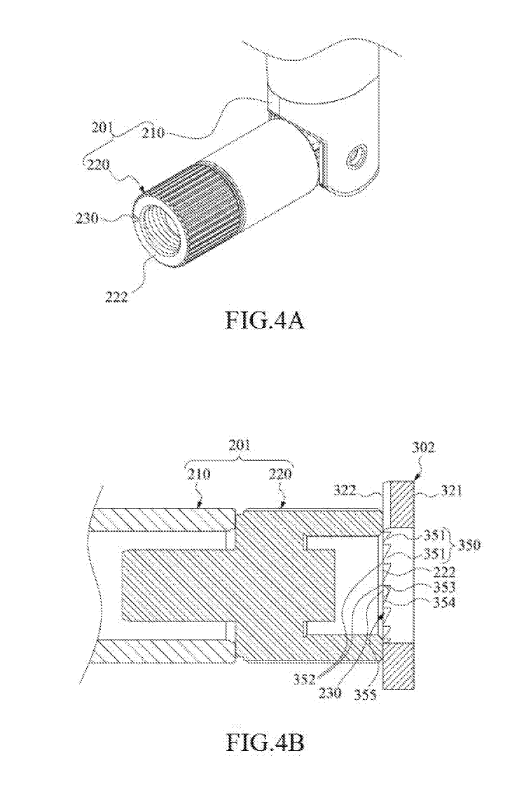

FIG. 4A is a schematic diagram showing an external antenna 201 in an embodiment. As shown in FIG. 3B and FIG. 4A, in an embodiment, the cushion washer 302 in FIG. 3B is applied. The end face 222 of the second connector 220 in FIG. 4A includes a bump 230. The bump 230 protrudes towards a direction that is opposite to the antenna body 210.

FIG. 4B is a longitudinal cross-section view of the cushion washer 302 in FIG. 3B and the external antenna 201 in FIG. 4A that are assembled in an embodiment. To clearly show the connection between the bump 230 and the solid friction pattern 350, partial of the main body is not shown in FIG. 4B.

As shown in FIG. 4B, when the cushion washer 302 and the external antenna 201 are assembled, the bump 230 enters into the solid friction pattern 350. That is, the bump 230 enters into the gap 355 between any two adjacent second protrusions 351. The bump 230 abuts against the vertical surface 353 of the second protrusion 351 of the cushion washer 300. Thus, the second connector 220 is restricted, it would not rotate to disconnect from the cushion washer 302. Thus, the external antenna does not easily loose from the main body and does not unexpectedly sag relatively to the antenna connector.

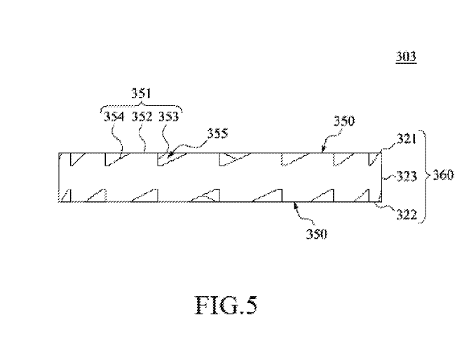

FIG. 5 is a side view of a cushion washer 303 in an embodiment. As shown in FIG. 3B and FIG. 5, a cushion washer 303 shown in FIG. 5 is similar to the cushion washer 302 in FIG. 3B. One difference is that the cushion washer 302 in FIG. 3B includes the solid friction pattern 350 at one side, in contrast, the cushion washer 303 in FIG. 5 includes the solid friction patterns 350 at two sides. That is, the solid friction patterns 350 of the cushion washer 303 are formed at both the first main surface 321 and the second main surface 322 of the ring body 360.

Since the solid friction patterns 350 contacts with the housing 110 and the second connector 220 directly, the connection between the second connector 220 of the external antenna 200 and the first connector 130 is enhanced. In an embodiment, the patterns of the cushion washer 303 in FIG. 5 is various according to requirements.

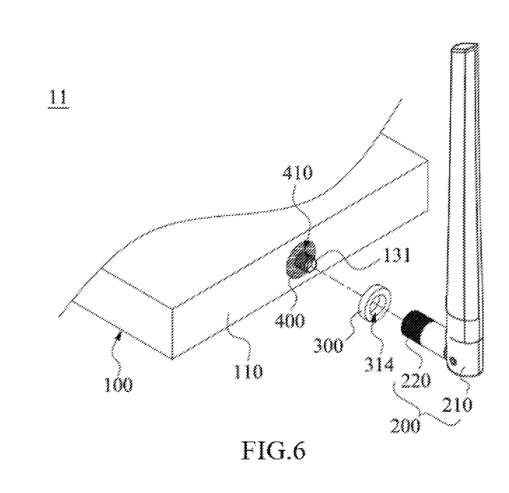

FIG. 6 is an exploded view of a wireless communication device 11 in an embodiment. As shown in FIG. 2 and FIG. 6, a wireless communication device 11 shown in FIG. 6 is similar to the wireless communication device 10 in FIG. 2. A difference is that the wireless communication device 11 shown in FIG. 6 further includes an adhesive layer 400.

The cushion washer 300 is attached to the outer surface of the housing 110 via the adhesive layer 400. That is, the adhesive layer 400 adheres to the cushion washer 300 and the main body 100. The adhesive layer 400 includes an opening 410. The opening 410 is aligned to the through hole 314 of the cushion washer 300 to allow the stud 131 to pass through. The cushion washer 300 is attached to the adhesive layer 400 of the housing 110. The connection stability between the external antenna 200 and the main body 100 is further improved.

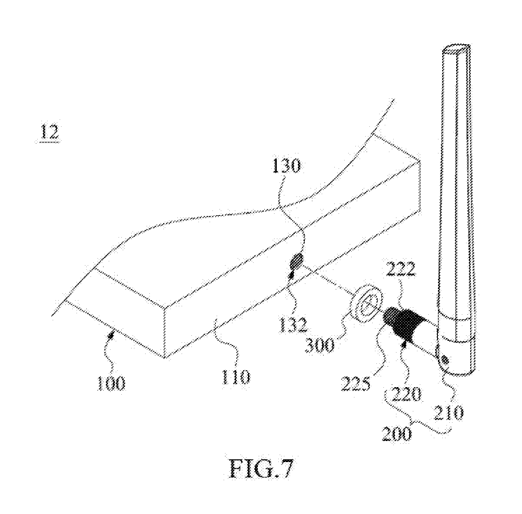

FIG. 7 is an exploded view of a wireless communication device 12 in an embodiment. As show in FIG. 7, the wireless communication device 12 shown in FIG. 7 is similar to the wireless communication device 10 in FIG. 2. A difference is that the first connector 130 in FIG. 7 includes a screw channel 132. The screw channel 132 is formed on the outer surface of the housing 110. The second connector 220 includes a stud 225. The stud 225 passes through the cushion washer 300 to be screwed within the screw channel 132. The cushion washer 300 contacts with the end face 222 of the second connector 220 and the outer surface of the housing 110.

In sum, in embodiments, the wireless communication device includes a main body, an external antenna and a cushion washer. The external antenna is connected to the main body. The cushion washer is sandwiched between the external antenna and the main body. In such a way, whether the connection between the external antenna and the main body is weak or not, the connection between the external antenna and the main body is enhanced due to friction interfaces between the cushion washer with the external antenna and the main body. Thus, the external antenna does not easily loose from the main body and does not unexpectedly sag relatively to the antenna connector. Consequently, the appearance of the electronic device is improved and the stability of the signal transmission is ensured.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. A wireless communication device comprising:
a main body, including a first connector;
an external antenna, including a second connector detachably connected to the first connector; and
a cushion washer, sandwiched between the main body and the second connector.

2. The wireless communication device according to claim 1, wherein the cushion washer includes a ring body and a through hole, the ring body includes two opposite main surfaces, the through hole is formed through the ring body to the main surfaces.

3. The wireless communication device according to claim 2, the main surfaces are even surfaces that contacts with the main body and the second connector.

4. The wireless communication device according to claim 2, wherein the ring body further includes at least a solid friction pattern, the solid friction pattern is formed on at least one of the main surfaces, the solid friction pattern contacts with at least one of the main body and the second connector.

5. The wireless communication device according to claim 4, wherein the solid friction pattern includes a plurality of first protrusions that are separatedly arranged, and each of the first protrusion is hemispherical.

6. The wireless communication device according to claim 4, wherein the solid friction pattern includes a plurality of second protrusions, the second protrusions are separatedly arranged to surround the through hole, the second protrusion is wedge-shaped, each of the second protrusion includes a top surface, a vertical surface and an inclined surface, the top surface is connected to the vertical surface and the inclined surface, and the vertical surface of one of the second protrusions is adjacent to the inclined surface of an adjacent second protrusion of the second protrusions.

7. The wireless communication device according to claim 6, wherein an end face of the second connector includes a bump, and the bump enters into the solid friction pattern to abut against the vertical surface of one of the second protrusions.

8. The wireless communication device according to claim 1, wherein the wireless communication device further includes an adhesive layer, the adhesive layer adheres to the cushion washer and the main body.

9. The wireless communication device according to claim 1, wherein the second connector includes a threaded ring, the threaded ring includes a frictional side surface, an end face and a screw channel, the frictional side surface surrounds and adjoins the end face, the screw channel is configured at the end face, the main body further includes a housing, the first connector includes a stud, the stud passes through the housing and the cushion washer to be screwed within the screw channel, and the cushion washer contacts with the end face and the housing of the second connector.

10. The wireless communication device according to claim 1, wherein the main body further includes a housing, the first connector includes a screw channel, the screw channel is formed on the housing, the second connector includes a stud, the stud passes through the cushion washer to be screwed within the screw channel, and the cushion washer contacts with the end face and the housing of the second connector.
